(19) United States
(12) Patent Application Publication
(10) Pub. No.: US 2017/0079001 A1
(43) Pub. Date: Mar. 16, 2017

(54) Radio Beacon for Direction Detection

(71) Applicant: Google Inc., Mountain View, CA (US)

(72) Inventor: Peter Gregory Lewis, London (GB)

(21) Appl. No.: 14/855,129

(22) Filed: Sep. 15, 2015

(51) Int. Cl. H04W 64/00; H04W 40/24; H04W 4/00; H04W 4/02

(52) U.S. Cl. CPC H04W 64/00; H04W 4/02; H04W 40/244; H04W 4/008

(57) ABSTRACT

In embodiments of radio beacon for direction detection, a beacon differentiates a first packet in a sequence of packets for transmission. The beacon transmits the sequence of packets using an omnidirectional antenna and a number of directional antennas. The beacon transmits the differentiated, first packet using the omnidirectional antenna and transmits each of the other packets in the sequence of packets using a different one of the directional antennas for each transmission of the other packets. A mobile device receives the sequence of packets from the beacon and determines a direction of the mobile device relative to the beacon.

### BACKGROUND

Low-power radio beacons transmit information that is used by an application on a mobile device to provide location-relevant and/or context relevant information to a user. The transmission from the low-power radio beacon includes an identifier that the application can use to obtain contextual information from a service, such as a cloud-based service, that provides the contextual information related to the identifier of, and consequently, the location of the beacon. Low-power radio beacons are often used in indoor settings where signals from other location technologies, such as the Global Positioning System (GPS) signals, cannot be reliably received. Low-power radio beacons are also used indoors to provide higher resolution location information than can be provided by other radiolocation solutions, such as cellular-based location technologies that have larger location uncertainties due to propagation and attenuation effects of buildings and terrain.

Low-power radio beacons often use a single, omnidirectional (i.e., isotopically radiating) antenna. The mobile device receiving the signal from the low-power radio beacon may estimate a distance from the mobile device to the beacon based on the Received Signal Strength Indication (RSSI) of the received signal. The RSSI is calculated using software functions, often provided as Application Programming Interfaces (APIs), with the operating system or software of the mobile device. The RSSI is compared to an expected transmission power from the beacon to obtain a coarse estimate of distance. The accuracy of this distance estimation may vary widely based on the surroundings of the indoor setting.

### SUMMARY

This summary is provided to introduce simplified concepts of radio beacon for direction detection. The simplified concepts are further described below in the Detailed Description. This summary is not intended to identify essential features of the claimed subject matter, nor is it intended for use in determining the scope of the claimed subject matter.

In embodiments of radio beacon for direction detection, a beacon differentiates a first packet in a sequence of packets for transmission. The beacon transmits the sequence of packets using an omnidirectional antenna and a number of directional antennas. The beacon transmits the differentiated, first packet using the omnidirectional antenna. The beacon transmits each of the other packets in the sequence of packets using a different one of the directional antennas for the transmission of each of the other packets.

In embodiments of radio beacon for direction detection, a mobile device determines a direction from a beacon. The mobile device receives a sequence of packets transmitted by the beacon. The mobile device identifies a first position in the received sequence of packets and the mobile device identifies a second position in the received sequence of packets. Based on the identified first position and the second identified position, the mobile device determines a direction of the mobile device relative to the beacon.

In embodiments of radio beacon for direction detection, a system includes a beacon with an omnidirectional antenna and multiple, directional antennas. The beacon sequentially transmits a radio packet using the omnidirectional antenna and each of the directional antennas. The beacon differentiates the transmission of the radio packet using the omnidirectional antenna, from the transmissions of the radio packet using each of the directional antennas. The system also includes a mobile device that receives the sequence of radio packets transmitted by the beacon. The mobile device identifies a first position in the received sequence of radio packets corresponding to the transmission of the radio packet, by the beacon, using the omnidirectional antenna. The mobile device identifies a second position in the received sequence of radio packets corresponding to the transmission of the radio packet, by the beacon, using one of the directional antennas. Based on the identified first position and the identified second position, the mobile device determines a direction of the mobile device relative to the beacon.

### BRIEF DESCRIPTION OF THE DRAWINGS

Embodiments of radio beacon for direction detection are described with reference to the following drawings. The same numbers are used throughout the drawings to reference like features and components:

FIG. 1 illustrates an example system for embodiments of radio beacon for direction detection.

FIG. 2 illustrates an example antenna system for embodiments of radio beacon for direction detection.

FIG. 3 illustrates an example radiation pattern for an antenna system for embodiments of radio beacon for direction detection.

FIG. 4 illustrates an example device for embodiments of radio beacon for direction detection.

FIGS. 5A and 5B illustrate example transmission sequences for embodiments of radio beacon for direction detection.

FIGS. 6A and 6B illustrate example reception sequences for embodiments of radio beacon for direction detection.

FIG. 7 illustrates an example system for embodiments of radio beacon for direction detection.

FIG. 8 illustrates example method(s) of radio beacon for direction detection in accordance with one or more embodiments.

FIG. 9 illustrates additional example method(s) of radio beacon for direction detection in accordance with one or more embodiments.

FIG. 10 illustrates various components of an example device that can implement embodiments of radio beacon for direction detection.

### DETAILED DESCRIPTION

In embodiments, a beacon (i.e., radio beacon) transmits a sequence of packets (i.e., radio packets) using one of multiple antennas for each transmitted packet. A first packet is transmitted using an omnidirectional (i.e., isotopically radiating) antenna. Each of the remaining packets is transmitted using one of multiple, directional antennas. The multiple, directional antennas are oriented to radiate in sectors around the beacon, with the radiation of each directional antenna covering only a portion of the isotropic region of the omnidirectional antenna.

The transmission of the first packet is differentiated in the sequence of packets to make the first packet readily identifiable by a receiver. As discussed in detail below, the first packet may be transmitted at a higher power than the other packets in the sequence of packets. Alternatively, the timing of the first packet, relative to the remaining packets in the sequence of packets, may be such that the transmission of the first packet can be identified at the receiver.

A mobile device that receives transmissions from the beacon measures a signal strength of each received packet in the sequence of packets, typically by measuring a Received Signal Strength Indication (RSSI). An application that uses information from beacons accesses the RSSI for each of the packets in the sequence of packets. By comparing the RSSI values for the sequence of received packets, the application identifies which packet is the first packet in the sequence of packets. The application identifies which one of the remaining packets in the sequence has the highest RSSI value among the remaining packets. By comparing the position of the first packet and the position of the packet with the highest RSSI value of the remaining packets, the application can determine in which sector of the beacon the mobile device is located.

When receiving packets from a beacon, with a single, omnidirectional antenna, the application can only determine a coarse estimate of a distance from the beacon. When receiving the sequence of packets from the beacon, the application can determine both a direction and, optionally, a corresponding estimate of distance, which provides the application with higher resolution location information to better identify the location of the mobile device.

When the mobile device is in an environment where multiple beacons are transmitting using single, omnidirectional antennas, the application can attempt to identify the location of the mobile device, by estimating distances to each of the beacons to determine a location. However, many indoor environments may introduce uncertainty into this determination of location, such as metal shelving in a retail store that reflects and attenuates radio signals.

The application that receives sequences of packets from multiple beacons, each using an omnidirectional antenna and multiple, directional antennas, determines which sector has the highest RSSI value for each of the multiple beacons. The application uses the highest RSSI values from each beacon to determine a direction from each beacon to the mobile device. The application determines a more accurate and/or a higher resolution location of the mobile device from the multiple beacons using the direction information, with or without using the estimated distances to each beacon.

The application on the mobile device uses the determined location and/or direction information to obtain and provide context-relevant information. For example, the application obtains contextual information from a cloud-based service to provide location-specific advertising or alerts to a user moving within an environment, such as a store. The higher resolution location information determined from the beacon enables the application to provide more location regions, as well as smaller, more focused, regions, for the contextual information. For example, in a retail store the application can present a greater number of location-specific advertisements to users.

There are applications where simply using the direction information from the beacon is valuable. A beacon may be attached to a piece of equipment that is mobile. The application uses the contextual information to determine information related to the current bearing of the mobile device from the equipment. For example, the application can determine if the mobile device is located in a safe area or dangerous area around a piece of mobile equipment, such as construction equipment and so forth.

The more accurate location information determined from the beacon enables the application to reduce errors in obtaining and providing the correct contextual information to a user. Accuracy can be further improved by surveying the environment in which the beacon operates. RSSI information is collected at multiple locations in the environment in which the beacon is deployed. By mapping the RSSI values for the sectors of the radio beacon to locations within the operating environment, the application or the service that provides the contextual information can compensate for variations in radio propagation, further insuring that accurate contextual information is provided to the user.

While features and concepts of the described systems and methods for radio beacon for direction detection can be implemented in any number of different environments, systems, devices, and/or various configurations, embodiments of radio beacon for direction detection are described in the context of the following example devices, systems, and configurations.

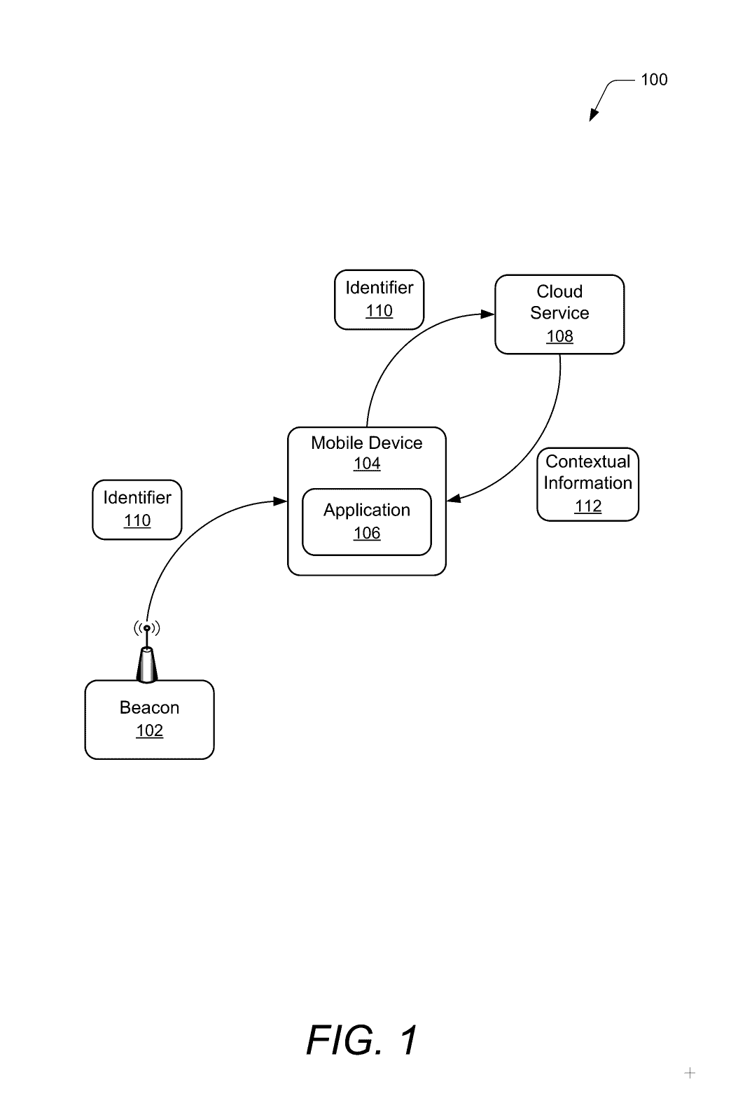

FIG. 1 illustrates an example system 100 in which various embodiments of radio beacon for direction detection can be implemented. The example system 100 includes a beacon 102, such as a Bluetooth Low Energy (BLE) beacon that transmits beacon packets for reception by any type of a mobile device 104. While some embodiments are described in the context of BLE beacons, the beacon 102 may use any suitable wireless technology, by way of example and not limitation, any Wireless Person Area Network (WPAN), Wireless Local Area Network (WLAN), Wireless Wide Area Network, (WWAN), short-range radio, Near Field Communication (NFC), and the like.

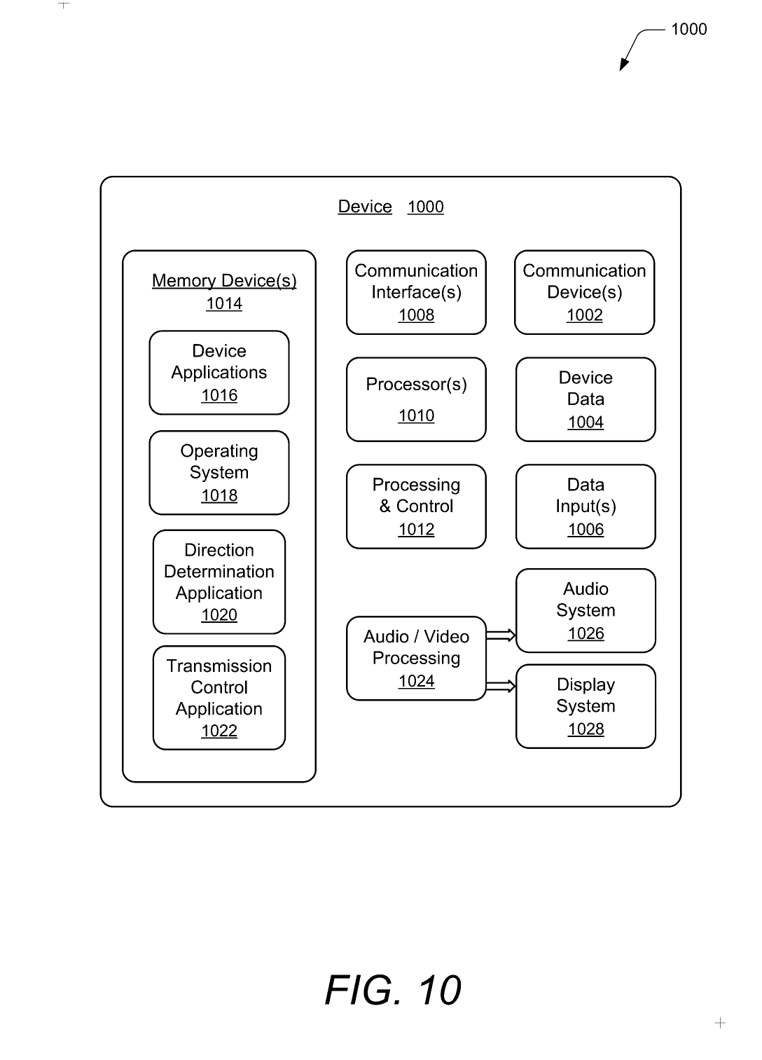

The mobile device 104 is any suitable mobile device, such as a smartphone, tablet, notebook computer, smart watch, and/or wearable device, which includes a receiver capable of receiving packets transmitted by the beacon 102. The mobile device 104 may be implemented with any number and combination of differing components as further described with reference to the example device shown in FIG. 10.

An application 106 executes on the mobile device 104 to determine a direction from one or more of the beacons 102 to the mobile device 104. (For the sake of clarity, a single beacon 102 is illustrated in FIG. 1; however, the principles described here apply equally to environments with multiple beacons 102.) The application 106 also interacts with a server or service, such as a cloud service 108, over any suitable network or combination of wired and/or wireless networks, such as the Internet.

The application 106 uses software and/or hardware functions and/or interfaces, such as Application Programming Interfaces (APIs), provided with the mobile device 104 or an operating system of the mobile device 104. The application 106 uses the APIs to access information transmitted by the beacon 102, such as an identifier 110 that is included the packets transmitted by the beacon 102. The application 106 may also access information about radio transmissions, such as an RSSI for a packet received from the beacon 102.

The application 106 sends the identifier 110, which was received from the beacon 102, to the cloud service 108. The cloud service 108 uses the identifier 110 to provide contextual information 112, which corresponds to the identifier 110, to the application 106. For example, the cloud service 108 may store identifiers 110 and associated context information 112, in any suitable manner, such as in a database. When the cloud service 108 received an identifier 110, the cloud service 108 retrieves the associated contextual information 112 and provides the contextual information 112 to the application 106. The application 106 uses the contextual information 112 to perform a contextually-relevant operation on the mobile device 104.

By way of example, the cloud service 108 is a beacon registry that stores various pieces of information associated to the beacon 102 by the identifier 110. The beacon registry stores information including the status of the beacon, the stability of the beacon, the latitude and longitude of the beacon, an indoor floor level of the beacon, a textual description, a place identifier and/or additional properties. For example, the additional properties may be stored as key/value pairs, such as key/value pairs that are associated with the sectors around the beacon 102.

For example, the application 106 may be a shopping application where the contextual information 112 enables the shopping application to present an electronic coupon to the user for a product near the mobile device 104. In another example, the application 106 may be a tour-guide application for a museum, where the contextual information 112 enables the tour-guide application to provide information that enhances a user's understanding of a nearby exhibit.

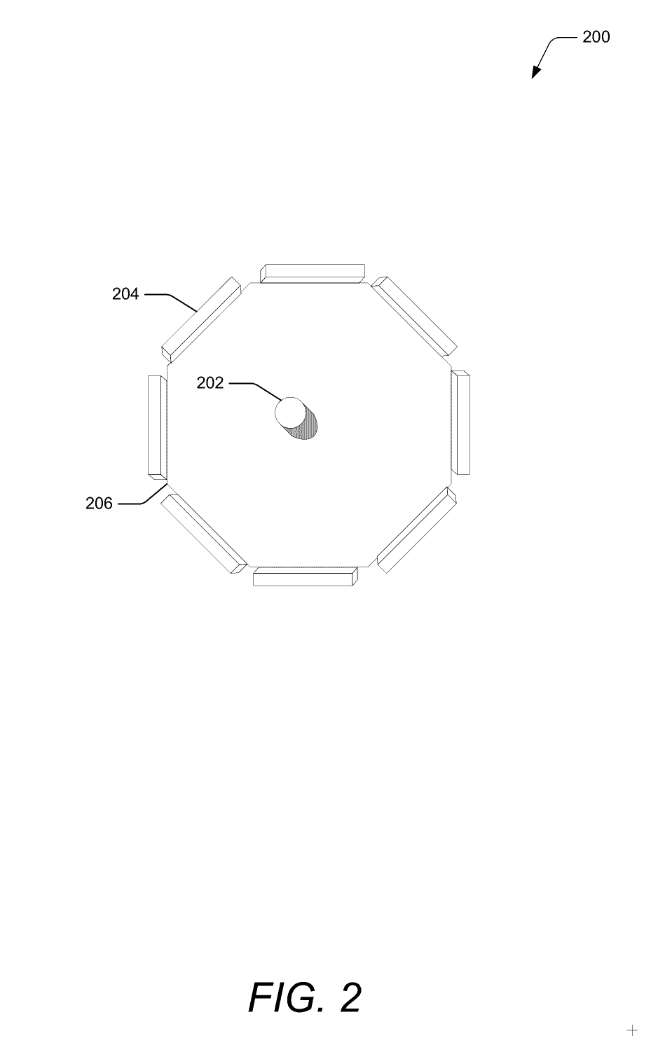

FIG. 2 illustrates an example antenna system 200 in which various embodiments of radio beacon for direction detection can be implemented. The example system 200 includes an omnidirectional antenna 202 and multiple directional antennas 204 (for the sake of clarity, a single directional antenna 204 of the eight illustrated directional antennas in FIG. 2 is labeled at 204). The omnidirectional antenna 202 is located at the center of the antenna system 200. The directional antennas 204 are generally arranged about the omnidirectional antennas 202 such that the directional antennas 204 radiate outward in sectors with respect to the omnidirectional antenna 202, although other arrangements of the antennas are contemplated.

The omnidirectional antenna 202 and the directional antennas 204 are illustrated as attached to a mounting substrate 206, which by way of example and not limitation may be any suitable mounting material, such as a printed circuit board. The mounting substrate 206 may also act as a ground plane for the antenna system 200. Alternatively, the antenna system 200 may be fabricated using any other suitable technique or combination of techniques, including three-dimensional (3D) printing, and/or a mechanical assembly.

By way of example and not limitation, the antenna system 200 is illustrated with eight directional antennas 204 and thus radiating radio transmissions in eight sectors about the antenna system 200. The antennas system 200 can be configured using any suitable number, fewer or more, of the directional antennas 204.

The omnidirectional antenna 202 and/or the directional antennas 204 may be any suitable antenna technology, including, but not limited to, chip antennas, planar antennas, whip antennas, helical antennas, patch antennas, and so forth. Additionally, the mounting substrate 206 may be fabricated to include the omnidirectional antenna 202 and/or the directional antennas 204, for example using PCB, printed, and/or microstrip antennas, such as meander line antennas, inverted-F antennas, monopole antennas, dipole antennas, and so forth.

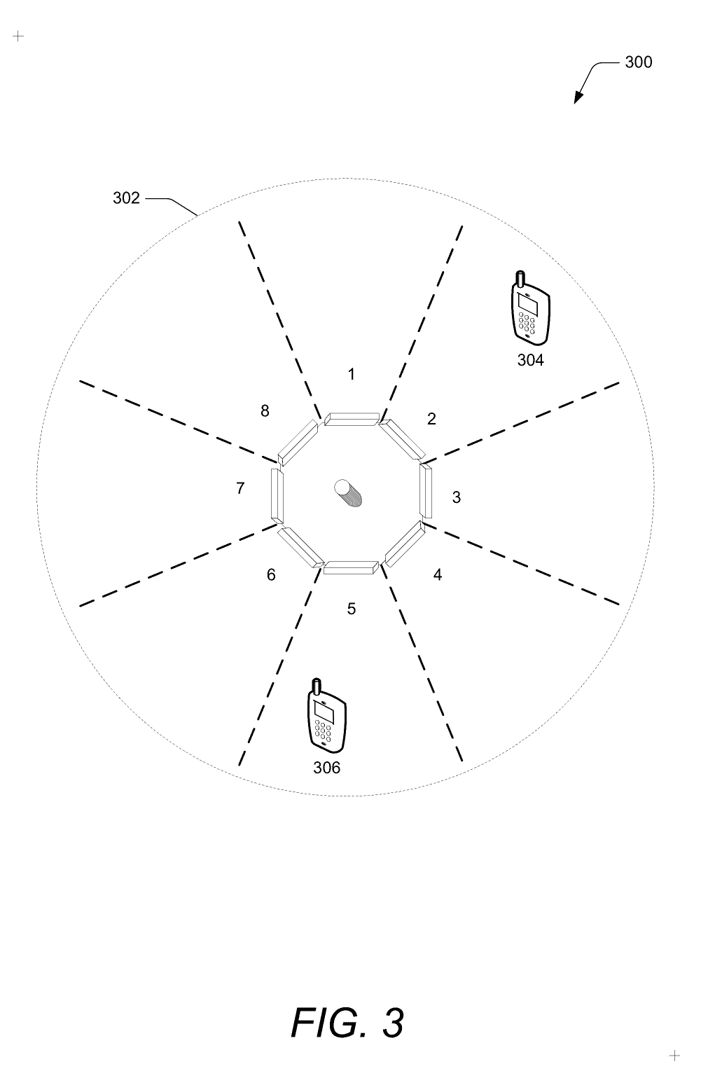

FIG. 3 illustrates an example radiation pattern 300 for the antenna system 200. The isotropic radiation pattern from the omnidirectional antenna 202 is shown at 302. The sectors (numbered 1-8) illustrate the radiation of the directional antennas 204. By way of example and not limitation, the numbering, and the associated sequence of transmissions, of the sectors is illustrated in a clockwise manner around the antenna system 200. Any suitable order and/or arrangement of sectors and sequencing during transmissions may be used.

For example, a mobile device 304 is shown in sector two, where the mobile device 304 will receive the signal transmitted by the directional antenna 204 of sector two with a higher RSSI than the signals from the directional antennas 204 of the seven other sectors. Likewise, a second mobile device 306 is shown in sector five, where the second mobile device 306 will receive the signal transmitted by the directional antenna 204 of sector five with a higher RSSI than the signals from the seven other sectors.

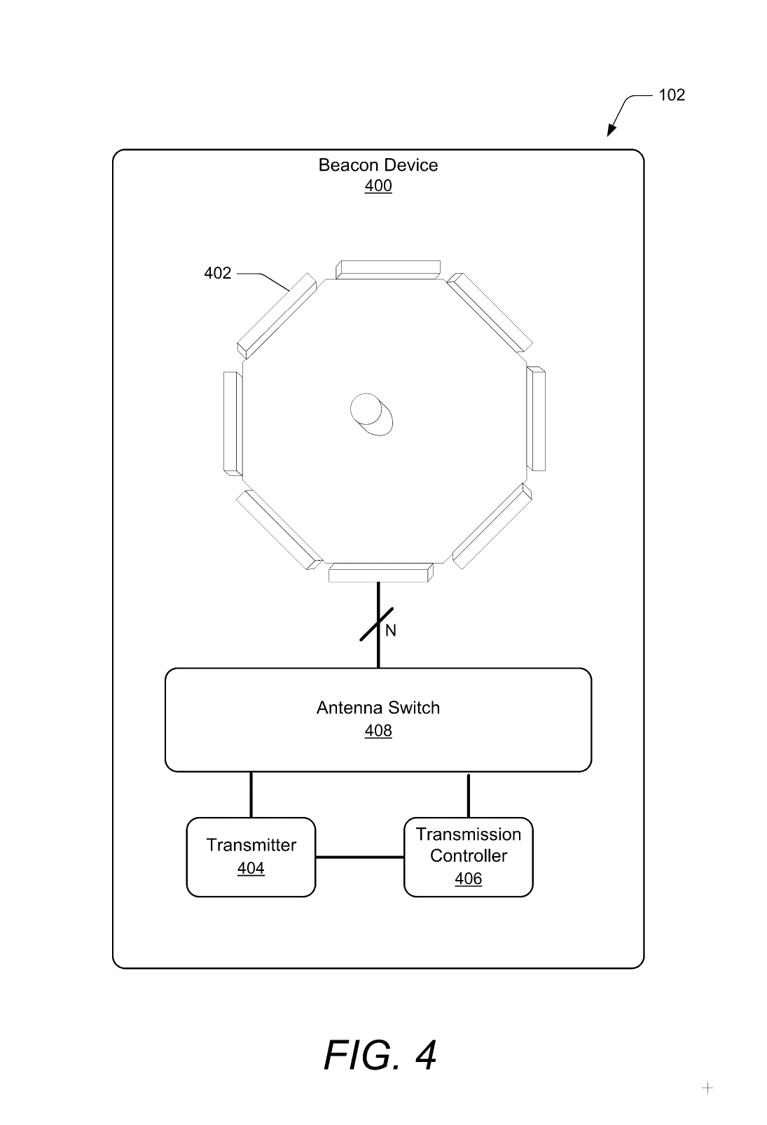

FIG. 4 illustrates an example beacon device 400 in which various embodiments of the beacon 102 of radio beacon for direction detection can be implemented. The example beacon device 400 includes the antenna system 200 (at 402), a transmitter 404, a transmission controller 406, and an antenna switch 408.

The transmitter 404 is coupled to the antenna switch 408 such that the output of the transmitter 404 can be coupled to any antenna in the antenna system 200. The transmitter 404 may be implemented in any suitable manner, such as a discrete or integrated transmitter, as part of a transceiver, or a single-chip radio system. The output of the transmitter 404 is only coupled to a single antenna in the antenna system 200 at any given time. The antenna switch 408 has one input port, which is connected to the transmitter 404 and a number, N, of output ports, where N is the total number of omnidirectional and directional antennas in the antenna system 200. The transmission controller 406 controls the selection of the output ports of the antenna switch 408.

The transmission controller 406 also controls the timing and/or output power for transmissions by the transmitter 404, such that packets are transmitted, as discussed in detail below. Although the sequence of packet transmissions in FIG. 3 is shown as proceeding clockwise around the beacon 102, the transmission controller 406 may be configured to sequence transmissions among the omnidirectional antenna 202 and the multiple, directional antennas 204 in any desired sequence.

In some embodiments, the transmission controller 406 may also be used to configure which antennas are enabled or disabled, based on the deployment location of the beacon 102. For example, if a beacon 102 is deployed against a wall, in a corner of two walls, or at any user-selected boundary in the deployment environment, the transmission controller 406 may be configured to disable transmission of any number of the directional antennas 204. Those directional antennas 204 that radiate toward a wall may not provide useful signals for the application 106 to determine a direction. The transmission controller 406 maintains the overall timing relationships for the sequence of packets across the total number of antennas, but does not transmit those packets (e.g., for antennas facing a wall) during the corresponding times for those packets in the sequence of packet transmissions. By reducing unwanted transmissions, a battery-powered beacon 102 will have a longer battery life and will avoid transmissions that increase the overall radio interference and/or noise levels in the deployment environment.

In another embodiment, the omnidirectional antenna 202 is not included in the antenna system 200. The transmission of the packet using the omnidirectional antenna 202 is simulated by concurrently transmitting the packet using all the directional antennas 202. For example, the antenna switch 408 is configured to connect the transmitter 404 to all of the directional antennas 204 to transmit the packet omnidirectionally, or the antenna switch 408 may include a power splitter to distribute the signal from the transmitter 404 to all of the directional antennas 204.

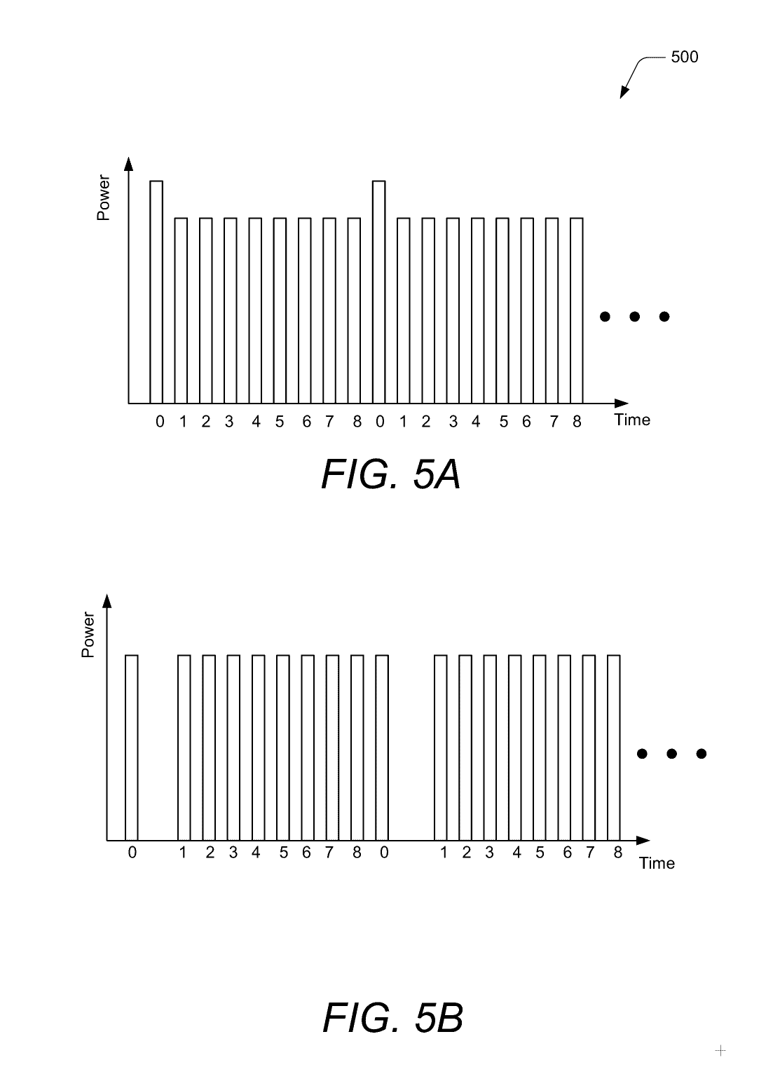

FIGS. 5A and 5B illustrate example transmission patterns for various embodiments of radio beacon for direction detection. In the FIGS. 5A and 5B, the relative heights of the bars, with respect to the vertical axes, illustrate transmitted power for packets transmitted by the beacon 102. The horizontal axes show the relative timing of packet transmissions by the beacon 102. Each vertical bar in FIGS. 5A and 5B corresponds to the transmission of a packet. By way of example and not limitation, the packet transmission is the transmission of a BLE packet on a BLE advertising channel.

By way of example, FIG. 5A illustrates transmission using the omnidirectional antenna 202 and eight directional antennas 204; however, this example applies to other numbers of directional antennas 204 as well. A sequence of packets is transmitted by the beacon 102, with one packet being transmitted using the omnidirectional antenna 202 (shown at position “0” in FIG. 5A) followed in succession by transmission of the packet on each of the directional antennas 204 (shown at “1”-“8” in FIG. 5A). The sequence of packets is transmitted periodically and may be transmitted with, or without, a delay between successive transmissions. For example, the choice of using the delay and the value of the delay may be based on factors such as battery life of the beacon 102, latency in determining successive directions at the mobile device 104, and so forth.

The packet transmitted using the omnidirectional antenna 202 is transmitted at a higher power than the packets transmitted using the directional antennas 204. The different transmission power levels are used to differentiate the sectors of the beacon 102 as discussed in further detail below. In embodiments, the higher transmission power using the omnidirectional antenna 202 may be achieved in any suitable way, such as by increasing the output power of the transmitter 404 when the omnidirectional antenna 202 is connected to the transmitter 404. Alternatively, the higher transmission power using the omnidirectional antenna 202 may be achieved by reducing the output power of the transmitter 404 when any of the directional antennas 204 are connected to the transmitter 404, or by using an omnidirectional antenna 202 with a relatively higher antenna gain than the directional antennas 204, which results in a higher effective radiated power (ERP) for transmission using the omnidirectional antenna 202.

In an alternative example, FIG. 5B illustrates transmission using the omnidirectional antenna 202 and eight directional antennas 204; however, this example applies to other numbers of directional antennas 204 as well. A sequence of packets is transmitted by the beacon 102, with one packet being transmitted using the omnidirectional antenna 202 (shown at “0” in FIG. 5B) followed in succession by transmission of a packet on each of the directional antennas 204 (shown at “1”-“8” in FIG. 5B). There is a longer period of time between transmission of a packet using the omnidirectional antenna 202 and the transmission using the first of the directional antennas 204. The timing between transmissions using the directional antennas 204 is consistent and shorter than the longer time period that follows the transmission using the omnidirectional antenna 202. The different transmission timings are used to differentiate the transmission of the first packet in the sequence of packets, as discussed in further detail below.

The sequence of packets is transmitted periodically and may be transmitted with, or without, a delay between successive transmissions. For example, the choice of using the delay and the value of the delay may be based on factors such as battery life of the beacon 102, latency in determining successive directions at the mobile device 104, and so forth.

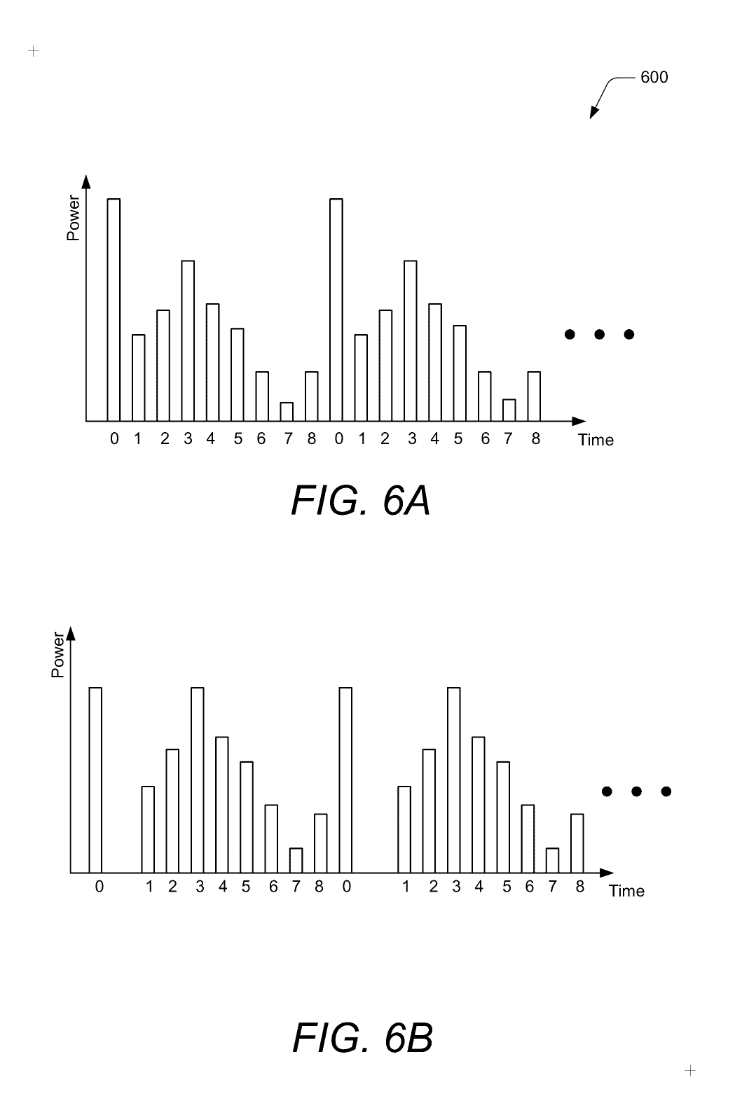

FIGS. 6A and 6B illustrate example RSSI patterns for various embodiments of radio beacon for direction detection. In the FIGS. 6A and 6B, the relative heights of the vertical bars, with respect to the vertical axes, illustrate RSSI values for packets transmitted by the beacon 102 and received at the mobile device 104. The horizontal axes show the relative timing of packet transmissions by the beacon 102, as received at the mobile device 104. Each bar in FIGS. 6A and 6B corresponds to the reception of a packet. By way of example and not limitation, the reception of a BLE packet on a BLE advertising channel.

By way of example, FIG. 6A illustrates reception of a packet transmitted using the omnidirectional antenna 202 that has a higher RSSI level than the packets received from transmissions using the eight directional antennas 204. The higher RSSI (as shown at position “0” in FIG. 6A) corresponds to the higher transmission power for packet transmitted using the omnidirectional antenna 202 (as shown at position “0” in FIG. 5A). The application 106 evaluates the RSSI values that correspond to the received packets. The application 106 identifies the packet with the highest RSSI value, in the sequence of received packets, as the packet transmitted using the omnidirectional antenna 202. The application 106 uses the position identified as having the highest RSSI value as a reference in the sequence of received packets to determine the sector, and thus the direction, from the beacon 102 to the mobile device 104. The application 106 compares the other RSSI values in the sequence to identify the second largest RSSI value (as illustrated at position “3” in FIG. 6A) to determine the sector of the beacon 102 in which the mobile device 104 is located. By using the RSSI values, coupled with the pattern of transmission power levels of the beacon 102, sector information does not need to be encoded in transmitted packets or decoded in received packets to determine the direction of the mobile device 104 from the beacon 102. For example, the content of each transmitted packet may include identical information, such as the identifier 110 for the beacon 102, and does not need to include any indication of the current sector or a position in the transmission sequence at the beacon 102.

By way of example, FIG. 6B illustrates reception of a packet transmitted using the omnidirectional antenna that was transmitted using the timing illustrated in FIG. 5B. The difference of timing in the transmission of the packet is used to identify the packet received from the omnidirectional antenna 202 with respect to the portion of the sequence of packets received from the directional antennas 204. The packet received from the omnidirectional antenna 202 (as shown at position “0” in FIG. 6B) provides a reference in the sequence of received packets to determine the sector, and thus the direction, from the beacon 102 to the mobile device 104. The application 106 compares the other RSSI values in the sequence to identify the largest RSSI value from the packets transmitted using the directional antennas 204 to determine the sector of the beacon 102 in which the mobile device 104 is located (in the example of FIG. 6B, sector “3”). By using the timing pattern of transmissions of the beacon 102, the beacon 102 does not need to encode sector information in transmitted packets, nor does the mobile device 104 need to decode sector information from received packets to determine the direction of the mobile device 104 from the beacon 102.

With respect to the embodiments described with respect to FIGS. 6A and 6B, two adjacent packets may have identical RSSI values, in the portion of the sequence of packets received from the directional antennas. The identical RSSI values for the two adjacent packets indicate that the mobile device 104 is located at, or very near, a boundary between two adjacent sectors of the beacon 102. To resolve which of the two sectors to use to determine the direction, any of a number of techniques may be used, such as evaluating a history of previous direction determination(s) to ascertain a direction of movement, using a previously determined direction until there is a single greatest RSSI value, and the like. Identical RSSI values may be values that are identical or values with less than a specified difference, such as a difference that falls below a threshold value, between the two RSSI values.

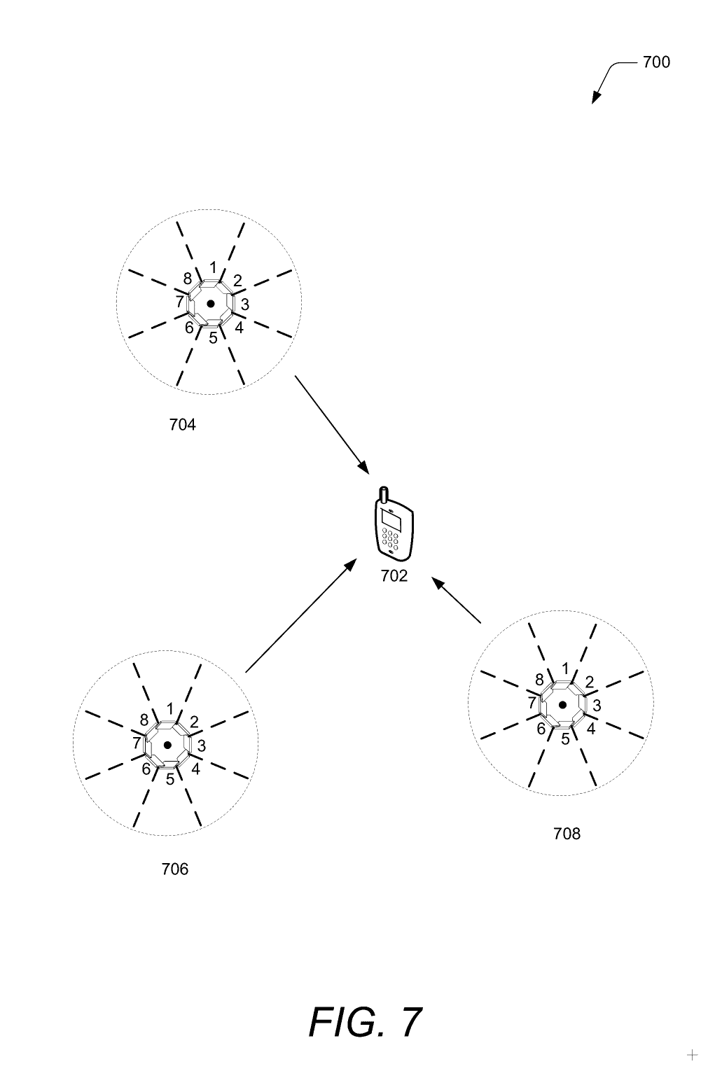

FIG. 7 illustrates an example environment 700 for various embodiments of radio beacon for direction detection. The mobile device 104 is shown as a mobile device 702 that is within range of multiple beacons 102, illustrated at 704, 706, and 708. Although illustrated as an example with three beacons 102 in FIG. 7, the following description applies equally to using other numbers of the beacons 102.

The mobile device 702 receives sequences of packets transmitted from the beacons 704, 706, and 708, using any of the embodiments described herein. The application 106 in the mobile device 702 determines that the mobile device 702 is located in sector four of the beacon 704, in sector two of the beacon 706, and in sector eight of the beacon 708.

In FIG. 7, the beacons 704, 706, and 708 are shown as being deployed with a consistent orientation such that the sectors of each beacon 102 are aligned in the same direction. When there is consistent orientation of the beacons 102, the application 106 and/or the cloud service 108 can determine an accurate location of the mobile device 702 in the environment 700, based on the determined directions, using known location finding techniques, such as triangulation, trilateration, and so forth. Additionally, it may be desirable to include survey information, as described below, in the determination of the location of the mobile device 702 to compensate for variations in radio propagation in the environment.

If the beacons 704, 706, and 708 are not deployed with a consistent orientation, an accurate location of the mobile device 702 can still be determined. As discussed above, the deployment environment is surveyed to measure RSSI values for each sector of each beacon in the environment. The application 106 uses the received packets from the beacons 704, 706, and 708, as well as a mapping of the RSSI values from the survey of the sectors of the beacons 704, 706, and 708 to calculate an accurate location of the mobile device 702 in the environment 700.

In addition to the single mobile device 702 determining a direction from any beacon 102, two mobile devices 702, which are within range of a common beacon 102, determine relative directions to each other. The two mobile devices 702 are connected by any suitable network, such that applications on the mobile devices 702 communicate direction information that each has determined from the common beacon 102. Each mobile device 702 knowing its direction from the beacon 102 and receiving direction information from the other mobile device 702 determines a relative direction between the two mobile devices 702.

By way of further example, one of the two mobile devices 702 is located in a known position relative to the common beacon 102, for example at a store entrance. Using context information and direction information determined by the other of the two mobile devices 702, the mobile devices 702 determine relative directions between each other.

When a new beacon 102 is deployed that has not been oriented to be consistent with the orientation of other beacons 102. Based on received contextual information 112 and directions determined to other beacons 102, the application on the mobile device 702 identifies a correct orientation for the new beacon 102 so that the new beacon 102 is consistently oriented with the other beacons 102. The mobile device 702 may configure the new beacon 102, transmit the orientation information to another device that configures the beacons 102, or transmit the orientation information to the new beacon 102 that reconfigures itself. The new beacon 102 reconfigures the transmission sequence of the directional antennas 204 to transmit in a manner consistent with the orientation of the other beacons 102.

Example methods 800 and 900 are described with reference to respective FIGS. 1-7 in accordance with one or more embodiments of radio beacon for direction detection. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

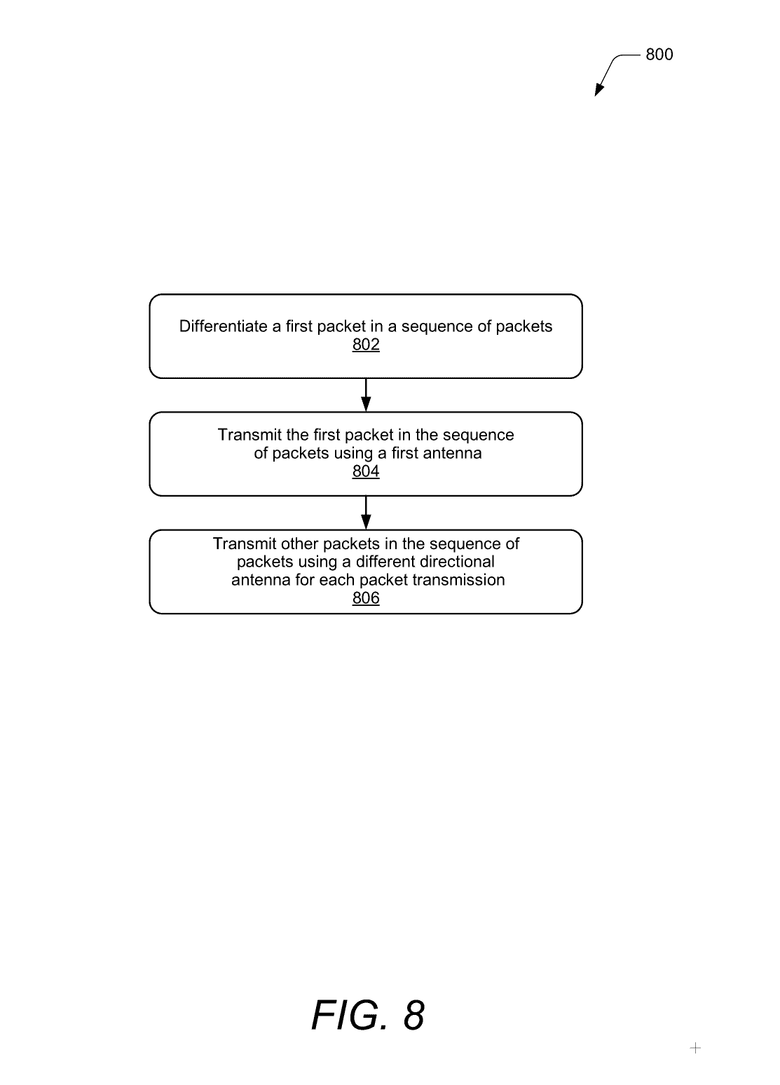

FIG. 8 illustrates example method(s) 800 of radio beacon for direction detection. The order in which the method blocks are described are not intended to be construed as a limitation, and any number of the described method blocks can be combined in any order to implement a method, or an alternate method.

At block 802, a first packet in a sequence of packets is differentiated for transmission. For example, the transmission controller 406 of the beacon 102 differentiates a first packet in a sequence of packets by changing a characteristic of the transmission of the first packet with respect to the characteristics used to transmit the other packets in the sequence of packets.

At block 804, the differentiated, first packet is transmitted using a first antenna. For example, the transmission controller 406 configures the antenna switch 408 to connect the output of the transmitter 404 to the first antenna, such as the omnidirectional antenna 202, of the antenna system 200. Alternatively, the transmission controller 406 configures the antenna switch 408 to connect the output of the transmitter 404 to all of the directional antennas 204 to transmit the packet omnidirectionally, the composite of all the directional antennas 204 acting as the first antenna.

At block 806, the other packets in the sequence of packets are transmitted using a different directional antenna for each packet transmission. For example, the transmission controller 406 configures the antenna switch 408 to connect the output of the transmitter 404 to a different directional antenna 204 of the antenna system 200 for the transmission of each of the packets, other than the first packet, in the sequence of packets.

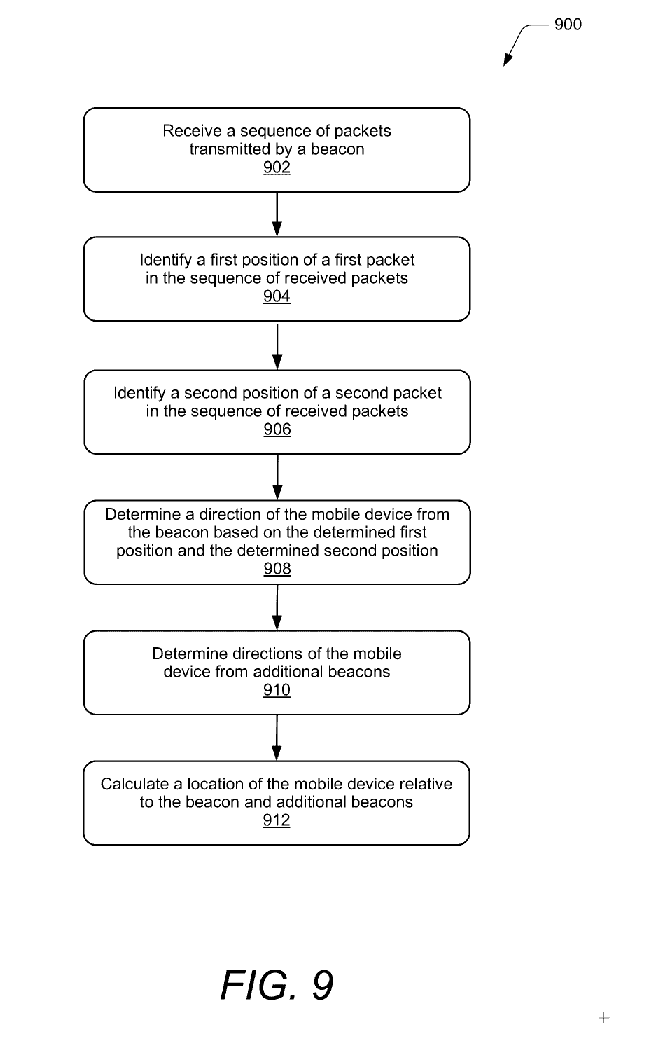

FIG. 9 illustrates example method(s) 900 of radio beacon for direction detection. The order in which the method blocks are described are not intended to be construed as a limitation, and any number of the described method blocks can be combined in any order to implement a method, or an alternate method.

At block 902, a mobile device receives a sequence of packets transmitted by a beacon. For example, the mobile device 104 receives a sequence of packets transmitted by the beacon 102 (e.g., a sequence of packet transmissions as shown in FIG. 5A or FIG. 5B).

At block 904, a first position of a first packet in the sequence of packets is identified. For example, the mobile device 104 identifies a position of a first packet (e.g., the packets indicated at position “0” in FIGS. 6A and 6B), such as basing the identification on RSSI values and/or timing characteristics of the packets in the sequence of packets.

At block 906, a second position of a second packet in the sequence of packets is identified. For example, the mobile device 104 identifies a position of a second packet (e.g., the packets indicated at position “3” in FIGS. 6A and 6B), that has the greatest RSSI value of the received packets, excluding the received packet identified as the first packet in the sequence of packets.

At block 908, based on the identified first position and the identified second position, a direction of the mobile device from the beacon is determined. For example, the mobile device 104 uses the first position that was identified (e.g., position “0” in FIGS. 6A and 6B), and the second position that was identified (e.g., position “3” in FIGS. 6A and 6B), to determine the direction of the mobile device 104 from the beacon 102.

At block 910, directions of the mobile device from additional beacons are determined. For example, the mobile device 104 receives sequences of packets from additional beacons 102 and identifies first and second positions within those received sequences of packets in a manner described in blocks 902, 904, 906, and 908. Although block 910 is illustrated as occurring after blocks 902, 904, 906, and 908 in FIG. 9, block 910 may be performed concurrently with blocks 902, 904, 906, and 908, so that the mobile device 104 concurrently determines directions from multiple beacons.

At block 912, a location of the mobile device is calculated relative to the beacon and the additional beacons. For example, using the determined directions from the beacon 102 and the additional beacons 102, the mobile device retrieves contextual information 112 from the cloud service 108 that is associated with the identifier 110 of the beacon 102 and the additional beacons 102. The contextual information 112 includes location information for the beacon 102 and the additional beacons 102, which is used along with the determined directions from the beacon 102 and the additional beacons 102 to calculate a location of the mobile device 104. The location information included in the contextual information 112 may be represented in any suitable manner, such as absolute locations expressed as latitude and longitude coordinates, user-defined, relative locations within the deployment environment of the beacon 102 and the additional beacons 102, and so forth.

FIG. 10 illustrates various components of an example device 1000 that can be implemented as any of the devices, or services implemented by devices, described with reference to the previous FIGS. 1-9. In embodiments, the device may be implemented as any one or combination of a fixed or mobile device, in any form of a consumer, computer, server, portable, user, communication, phone, navigation, television, appliance, gaming, media playback, and/or electronic device. The device may also be associated with a person and/or an entity that operates the device such that a device describes logical devices that include users, software, firmware, hardware, and/or a combination of devices.

The device 1000 includes communication devices 1002 that enable wired and/or wireless communication of device data 1004, such as received data, data that is being received, contextual information, data packets, sequences of packets, etc. The communication devices 1002 may include devices for communication using, by way of example and not limitation, any Wireless Person Area Network (WPAN), Wireless Local Area Network (WLAN), Wireless Wide Area Network, (WWAN), short-range radio, Near Field Communication (NFC), and the like. The device data or other device content can include configuration settings of the device, media content stored on the device, and/or information associated with a user of the device. Media content stored on the device can include any type of audio, video, and/or image data. The device includes one or more data inputs 1006 via which any type of data, media content, and/or inputs can be received, such as user-selectable inputs, messages, communications, music, television content, recorded video content, and any other type of audio, video, and/or image data received from any content and/or data source.

The device 1000 also includes communication interfaces 1008, such as any one or more of a serial, parallel, network, or wireless interface. The communication interfaces provide a connection and/or communication links between the device and a communication network by which other electronic, computing, and communication devices communicate data with the device.

The device 1000 includes one or more processors 1010 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits, which are generally identified at 1012. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 1000 also includes one or more memory devices (e.g., computer-readable storage media) 1014 that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 1014 provides data storage mechanisms to store the device data 1004, other types of information and/or data, and various device applications 1016. For example, an operating system 1018 can be maintained as a software application with a memory device and executed on the processors. The device applications may also include a device manager, such as any form of a control application, software application, signal processing and control module, code that is native to a particular device, a hardware abstraction layer for a particular device, and so on. In this example, applications include a direction determination application 1020, which generally performs the operations described above with respect to the application 106, such as when the device 1000 is implemented as a mobile device. The applications also include a transmission control application 1022, such as when device 1000 is implemented as a beacon, and generally performing the operations described above with respect to the transmission controller 406. The applications are shown as software modules and/or computer applications. Alternatively or in addition, the applications can be implemented as hardware, software, firmware, fixed logic, or any combination thereof.

The device 1000 also includes an audio and/or video processing system 1024 that generates audio data for an audio system 1026 and/or generates display data for a display system 1028. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link.

Although embodiments of radio beacon for direction detection have been described in language specific to features and/or methods, the subject of the appended claims is not necessarily limited to the specific features or methods described. Rather, the specific features and methods are disclosed as example implementations of radio beacon for direction detection.

1. A method of determining a direction from a beacon comprising:
differentiating, at the beacon, a first packet in a sequence of packets, the sequence of packets comprising the first packet and a plurality of additional packets;
transmitting the sequence of packets from the beacon, said transmitting comprising:
transmitting the differentiated first packet using a first antenna; and
transmitting each of the additional packets in the sequence of packets using a different one of a plurality of directional antennas.

2. The method of claim 1, wherein said differentiating the first packet comprises configuring a transmitter in the beacon to transmit the first packet at a higher power than the additional packets in the sequence of packets.

3. The method of claim 1, wherein said differentiating the first packet comprises configuring the transmitter in the beacon to transmit the first packet with a timing relationship to the additional packets in the sequence of packets that is different than a second timing relationship between the additional packets in the sequence of packets.

4. The method of claim 1, wherein the first antenna is an omnidirectional antenna.

5. The method of claim 4, wherein the plurality of the directional antennas are disposed around the first antenna, the directional antennas being evenly spaced with respect to each other, and each of the directional antennas radiating in a different direction away from the omnidirectional antenna.

6. The method of claim 4, wherein the omnidirectional antenna is a composite of the plurality of the directional antennas, and wherein the differentiated first packet is transmitted concurrently using the plurality of the directional antennas.

7. The method of claim 1, wherein the packets are Bluetooth Low Energy (BLE) data packets and said transmitting the sequence of packets is performed on a BLE advertising channel.

8. The method of claim 1, wherein the packets comprise an identifier for the beacon that is usable to obtain contextual information associated with the identifier.

9. method comprising:
receiving, at a mobile device, a sequence of packets transmitted by a beacon including a first packet transmitted omnidirectionally and a plurality of packets transmitted directionally;
identifying a first position, in the received sequence of packets, of the first packet of the received sequence of packets transmitted omnidirectionally;
identifying a second position, in the received sequence of packets, of a second packet of the received sequence of packets transmitted directionally; and
determining, based on the identified second position with respect to the identified first position, a direction of the mobile device relative to the beacon.

10. The method of claim 9, wherein
said identifying the first position in the received sequence comprises identifying, as the first packet, a received packet with a greatest Received Signal Strength Indication (RSSI) value, and
said identifying, as the second packet, the second position in the received sequence of packets comprises identifying a second received packet with a second greatest RSSI value.

11. The method of claim 10, further comprising:
estimating a distance from the beacon to the mobile device based on the RSSI of the received first packet or the received second packet.

12. The method of claim 9, wherein
said identifying the first position comprises identifying, as the first packet, a received packet with a timing relationship to other received packets in the sequence of packets that is different than a timing relationship between the other received packets, and
said identifying the second position in the received sequence of packets comprises identifying, as the second packet, a second received packet with the greatest Received Signal Strength Indication (RSSI) value of the other received packets.

13. The method of claim 9, wherein the packets include an identifier of the beacon, the method further comprising:
transmitting the identifier to a cloud service; and
responsive to said transmitting the identifier, receiving contextual information associated with the identifier.

14. The method of claim 13, wherein the contextual information comprises information usable to identify a location of the mobile device in an environment around the beacon.

15. The method of claim 9, further comprising:
receiving, at the mobile device, one or more additional sequences of packets transmitted by one or more additional beacons;
for each of the one or more received additional sequences of packets:
identifying a first position of an additional first packet in the received additional sequence of packets; and
identifying a second position of an additional second packet in the received additional sequence of packets; and
determining based on the identified additional second position, relative to the identified additional first position, in each of the one or more received additional sequences of packets, a direction of the mobile device relative to each of the one or more additional beacons.

16. The method of claim 15, further comprising:
receiving contextual information associated with each of the one or more additional beacons, the associated contextual information including an indication of a location for each of the additional beacons; and
responsive to said receiving, calculating a location of the mobile device relative to the beacon and the one or more additional beacons.

17. A system comprising:
a beacon comprising an omnidirectional antenna and a plurality of directional antennas, the beacon configured to:
sequentially transmit a sequence of radio packets using the omnidirectional antenna and each of the plurality of directional antennas, the transmission using the omnidirectional antenna being differentiated from the transmissions using each of the plurality of directional antennas; and
a mobile device configured to:
receive the sequence of the radio packets transmitted by the beacon;
identify a first position, in the received sequence of radio packets, of the radio packet transmitted omnidirectionally using the omnidirectional antenna in the received sequence of radio packets;
identify a second position, in the received sequence of radio packets, of a second radio packet in the received sequence of radio packets, the second radio packet having been transmitted directionally by the beacon using one of the plurality of the directional antennas; and
determine, based on the identified second position with respect to the identified first position, a direction of the mobile device relative to the beacon.

18. The system of claim 17, further comprising:
a server configured to:
receive, from the mobile device, an identifier of the beacon, the identifier being included in the sequence of radio packets received by the mobile device from the beacon;
retrieve contextual information associated with the identifier; and
transmit the retrieved contextual information to the mobile device.

19. The system of claim 17, wherein the radio packet transmitted using the omnidirectional antenna is differentiated by either transmitting the radio packet at a higher power level than the transmissions using the directional antennas, or with a timing relationship to the other radio packets in the sequence of radio packets that is different than the timing relationship between the other radio packets in the sequence of radio packets.

20. The system of claim 17, further comprising:
a plurality of additional beacons, each of the additional beacons being configured to:
sequentially transmit an additional sequence of radio packets using a respective omnidirectional antenna and each of respective directional antennas of the additional beacon, the transmission using the respective omnidirectional antenna being differentiated from the transmissions using the respective directional antennas, and the additional sequence of radio packets comprising a respective identifier of the additional beacon; and
the mobile device being further configured to:
receive the one or more additional sequences of radio packets transmitted by the one or more additional beacons;
for each of the one or more received additional sequences of radio packets:
identify a first position of an additional first radio packet in the received additional sequence of radio packets; and
identify a second position of an additional second radio packet in the received additional sequences of radio packets; and
determine, based on the identified additional second position, relative to the identified additional first position, in each of the one or more received additional sequences of packets, a direction of the mobile device relative to each of the one or more additional beacons.
